(19) United States
(12) Patent Application Publication
(10) Pub. No.: US 2026/0367877 A1
(43) Pub. Date: Nov. 19, 2026

(54) LARGE MODEL-BASED CHAINED CODE GENERATION METHOD, APPARATUS, AND ELECTRONIC DEVICE

(71) Applicant: BEIJING BAIDU NETCOM SCIENCE TECHNOLOGY CO., LTD., Beijing (CN)

(72) Inventor: Wenhan SHEN, Beijing (CN)

(73) Assignee: BEIJING BAIDU NETCOM SCIENCE TECHNOLOGY CO., LTD., Beijing (CN)

(21) Appl. No.: 19/704,273

(22) Filed: Jun. 10, 2026

(30) Foreign Application Priority Data
Oct. 29, 2025 (CN) 202511566293.4

(51) Int. Cl. G06F 8/30; G06F 8/41; G06F 9/48

(52) U.S. Cl. CPC G06F 8/30; G06F 8/433; G06F 9/4843

(57) ABSTRACT

A method for generating chained code based on a large model, an apparatus, an electronic device, and a readable storage medium are disclosed, which relates to the technical field of artificial intelligence such as large model, deep learning, and natural language processing. The method for generating chained code based on a large model includes: obtaining a plurality of code generation subtasks and an execution order of the plurality of code generation subtasks according to a code generation requirement; executing the plurality of code generation subtasks sequentially according to the execution order using a large model to generate a plurality of code files respectively corresponding to each of the code generation subtasks; obtaining a code generation result corresponding to the code generation requirement according to the plurality of code files corresponding to the plurality of code generation subtasks.

The present application claims the priority of Chinese Patent Application No. 202511566293.4, filed on Oct. 29, 2025, with the title of “LARGE MODEL-BASED CHAINED CODE GENERATION METHOD, APPARATUS, AND ELECTRONIC DEVICE”. The disclosure of the above application is incorporated herein by reference in its entirety.

### FIELD OF THE DISCLOSURE

The present application relates to the field of computer technology, and particularly to the technical field of artificial intelligence such as a large model, deep learning, and natural language processing. It provides a method for generating chained code based on a large model, an apparatus, an electronic device, and a readable storage medium.

### BACKGROUND OF THE DISCLOSURE

With the rapid development of artificial intelligence technology, the code generation technology based on a large model has been widely applied in the field of software development.

However, in actual development scenarios, developers often need to face engineering-level code generation tasks, such as generating multi-page front-end applications, multiple service modules in a microservice architecture, and database-related multi-table operation code, etc. Furthermore, the interconnected code within the same project needs to maintain a consistent programming style, share the same dependency relationships, and maintain correct calling interfaces, etc.

However, existing code generation schemes, such as a single full-scale generation scheme (i.e., a large model outputs all code files at once using a prompt), suffer from problems such as inability to maintain association and poor consistency.

### SUMMARY OF THE DISCLOSURE

According to a first aspect of the present application, a method for generating chained code based on a large model is provided, including: obtaining a plurality of code generation subtasks and an execution order of the plurality of code generation subtasks according to a code generation requirement; executing the plurality of code generation subtasks sequentially according to the execution order using a large model to generate a plurality of code files respectively corresponding to each of the code generation subtasks; obtaining a code generation result corresponding to the code generation requirement according to the plurality of code files corresponding to the plurality of code generation subtasks.

According to a second aspect of the present application, there is provided an electronic device, including: at least one processor; and a memory communicatively connected with the at least one processor; wherein the memory stores instructions executable by the at least one processor, and the instructions are executed by the at least one processor to enable the at least one processor to perform a method for generating chained code based on a large model, wherein the method for generating chained code based on a large model includes: obtaining a plurality of code generation subtasks and an execution order of the plurality of code generation subtasks according to a code generation requirement; executing the plurality of code generation subtasks sequentially according to the execution order using a large model to generate a plurality of code files respectively corresponding to each of the code generation subtasks; obtaining a code generation result corresponding to the code generation requirement according to the plurality of code files corresponding to the plurality of code generation subtasks.

According to a third aspect of the present application, there is provided a non-transitory computer readable storage medium with computer instructions stored thereon, wherein the computer instructions are used for causing a method for generating chained code based on a large model, wherein the method for generating chained code based on a large model includes: obtaining a plurality of code generation subtasks and an execution order of the plurality of code generation subtasks according to a code generation requirement; executing the plurality of code generation subtasks sequentially according to the execution order using a large model to generate a plurality of code files respectively corresponding to each of the code generation subtasks; obtaining a code generation result corresponding to the code generation requirement according to the plurality of code files corresponding to the plurality of code generation subtasks.

It should be understood that the content described in this section is not intended to identify key or important features of embodiments of the present application, nor is the content used to limit the scope of the present application. Other features of the present application will become easily understood through the following description.

### BRIEF DESCRIPTION OF DRAWINGS

The appended drawings are provided for a better understanding of the present solution and do not constitute a limitation on the present disclosure. In the drawings:

FIG. 1 is a schematic diagram according to a first embodiment of the present application;

FIG. 2 is a schematic diagram according to a second embodiment of the present application;

FIG. 3 is a schematic diagram according to a third embodiment of the present application;

FIG. 4 is a schematic diagram according to a fourth embodiment of the present application;

FIG. 5 is a schematic diagram according to a fifth embodiment of the present application;

FIG. 6 is a block diagram of an electronic device for implementing the method for generating chained code based on a large model according to embodiments of the present application.

### DETAILED DESCRIPTION OF PREFERRED EMBODIMENTS

The following describes exemplary embodiments of the present application with reference to the drawings, which include various details of the embodiments of the present application to aid understanding, and the details should be considered merely exemplary. Therefore, a person of ordinary skill in the art should recognize that various changes and modifications can be made to the embodiments described herein without departing from the scope and spirit of the present application. Similarly, for clarity and brevity, descriptions of well-known functions and structures are omitted in the following description.

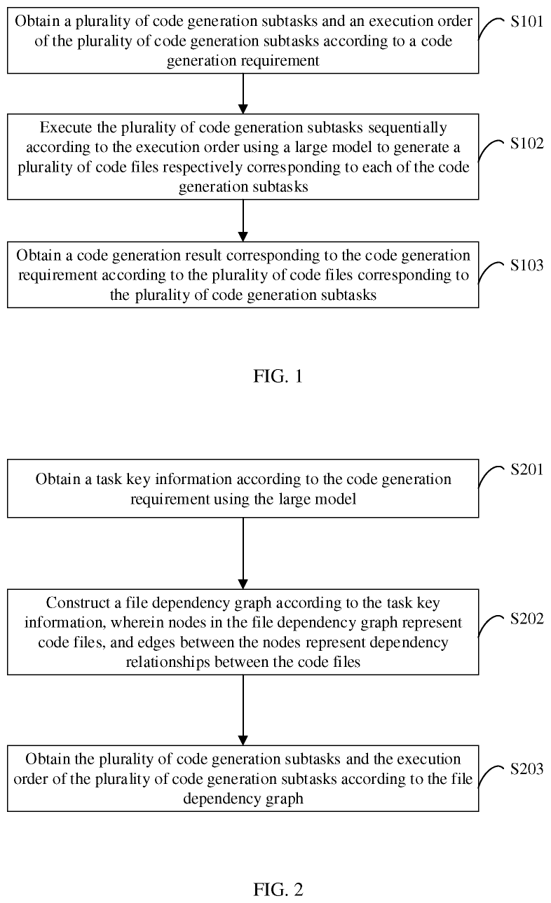

FIG. 1 is a schematic diagram according to a first embodiment of the present application. As shown in FIG. 1, the method for generating chained code based on a large model of the present embodiment specifically includes the following steps of:
S101, Obtaining a plurality of code generation subtasks and an execution order of the plurality of code generation subtasks according to a code generation requirement;
S102, Executing the plurality of code generation subtasks sequentially according to the execution order using a large model to generate a plurality of code files respectively corresponding to each of the code generation subtasks;
S103, Obtaining a code generation result corresponding to the code generation requirement according to the plurality of code files corresponding to the plurality of code generation subtasks.

The method for generating chained code based on a large model of the present embodiment, on one hand, decomposes a multi-code-file generation task into a plurality of ordered code generation subtasks to achieve the purpose of progressive code generation, so that in each call, the large model can fully focus its attention on a current code generation subtask, thereby “concentrating” on generating a specific code file. And on the other hand, by executing different code generation subtasks sequentially according to the execution order, the accuracy of task execution is improved, thereby enhancing the accuracy of the generated code files corresponding to different subtasks.

In other words, the method for generating chained code based on a large model of the present embodiment is applicable to different types of code generation tasks, particularly in engineering-level, multi-code-file, multi-page and other code generation scenarios. By decomposing to obtain a plurality of code generation subtasks and then having the large model sequentially execute different code generation subtasks, the integrity of dependencies and code consistency between the generated code files are ensured, thereby improving the accuracy of the resulting code files and code generation results.

In the present embodiment, the large model can be a large language model (LLM) or can be a multimodal large model (MLM).

When executing S101 in the present embodiment, an input from a user at an input terminal can be obtained as the code generation requirement. These code generation requirements reflect the functionality to be implemented by the code to be generated; for example, user input such as “Generate a real estate agency application” is used as the code generation requirement.

Different code generation subtasks obtained according to the code generation requirement when executing S101 in the present embodiment are used to generate different code files. These different code files contain different code content; that is, each code generation subtask in the present embodiment is a single code file generation task.

Each code generation subtask obtained when executing S101 in the present embodiment has a corresponding task information, with different task information reflecting different generation requirements. Different code generation subtasks correspond to different task information, which includes clearly defined input content, generation goals, and quality constraints.

After obtaining the plurality of code generation subtasks when executing S101 in the present embodiment, the execution order of the plurality of code generation subtasks is further obtained. Different execution orders are used to reflect generation orders of different code files.

This is because, in a multi-code-file generation scenario, a reference relationship inevitably exists between different code files, and the reference relationship reflects a dependency situation between code files. If the execution order of code generation subtasks is not determined, a problem that a dependent code file is generated later than a code file that depends on the dependent code file is likely to occur, thereby affecting the accuracy of the generated code files.

Therefore, when executing S101 in the present embodiment, the execution order of the plurality of code generation subtasks is determined based on a principle of “prioritizing the generation of dependent basic code files and gradually building the dependency hierarchy upwards”, ensuring that a dependent code file is generated before a code file that depends on the dependent code file.

When executing S101 in the present embodiment, multiple code generation subtasks and the execution order of the plurality of code generation subtasks can be obtained according to information included in the code generation requirement; For example, if the code generation requirement input by the user includes a plurality of code files that the user needs and dependency relationships between different code files, the present embodiment can obtain a plurality of code generation subtasks and the execution order of the plurality of code generation subtasks according to corresponding information directly extracted from the code generation requirement.

For example, if the code generation requirement obtained when executing S101 in the present embodiment is “generate three code files for implementing a corresponding application page, such as code file 1 for display, code file 2 for storage, and code file 3for management, where code file 2 needs to reference code file 1, and code file 3 needs to reference code file 2”, then when executing S101 in the present embodiment, a code generation subtask 1 corresponding to a code file 1, a code generation subtask 2corresponding to a code file 2, and a code generation subtask 3 corresponding to a code file 3 are respectively obtained, and the execution order of the three code generation subtasks is determined as “code generation subtask 1→code generation subtask 2→code generation subtask 3”.

After obtaining the plurality of code generation subtasks and the execution order of the plurality of code generation subtasks when executing S101 in the present embodiment, S102 is executed to use the large model to execute the plurality of code generation subtasks sequentially according to the execution order to generate a plurality of code files respectively corresponding to each of the code generation subtasks.

In other words, the present embodiment calls the large model multiple times according to the execution order to execute different code generation subtasks, thereby generating code files corresponding to different code generation subtasks by the large model through progressive code generation, with the generated code files including corresponding code content.

Since the large model only needs to focus on generating one specific file when executing a different code generation subtask each time, the generation target is relatively clear and the generation complexity is also relatively controllable. Therefore, during the generation process, the attention of the large model can be fully concentrated on the current task, avoiding an attention dilution problem when generating long sequences.

Specifically, when executing S102 to use the large model to execute the plurality of code generation subtasks sequentially according to the execution order to generate the plurality of code files respectively corresponding to each of the code generation subtasks in the present embodiment, an implementation method that can be as follows: for a current code generation subtask, obtaining a prompt for the current code generation subtask according to a task information and a historical code content corresponding to the current code generation subtask, wherein the prompt in the present embodiment is a Prompt; inputting the prompt into the large model, and obtaining a code file corresponding to the current code generation subtask according to an output result of the large model.

In other words, when the large model executes different code generation subtasks in the present embodiment, in addition to using the task information of the current code generation subtask, the historical code content corresponding to the current code generation subtask is also used. Therefore, when the large model generates a code file corresponding to the current subtask, the large model can “see” all previously related and determined code content, thereby not “forgetting” preceding code information during the generation process.

Therefore, in the code file generation process of the present embodiment, the code content of a preceding code file is used as a context for chained transmission, on one hand, enabling the large model to accurately reference a component, a function, a variable, a style, and other information defined in the preceding code file when executing different code generation subtasks, ensuring accurate establishment of dependency relationships between different code files, and achieving the purpose of maintaining dependency relationships during the generation process. On the other hand, it ensures that the large model can follow an established specification and a pattern when executing different code generation subtasks, thereby ensuring that different generated code files have a consistent coding style, a naming convention, and an architectural paradigm, etc., achieving the purpose of ensuring consistency during the generation process.

When executing S102 to obtain the prompt for the current code generation subtask according to the task information and the historical code content corresponding to the current code generation subtask in the present embodiment, the historical code content can be first extracted from the historical code file, then the extracted code content and the task information can be combined, and the combined result can be treated as the prompt for the current code generation subtask.

In the present embodiment, the historical code file corresponding to the current code generation subtask is all historical code files obtained before executing the current code generation subtask; Therefore, the historical code content in the present embodiment refers to all code content included in the historical code files.

However, in an actual usage scenario, the code generation subtasks obtained by decomposing according to the code generation requirement will include a plurality of subtasks. If the number of code generation subtasks is too large, it will lead to the problem of exceeding the context input length limit when using the corresponding historical code content as the context of a certain code generation subtask.

Therefore, when executing S102 to obtain the prompt for the current code generation subtask according to the task information and the historical code content corresponding to the current code generation subtask in the present embodiment, an implementation method can be as follows: obtaining a context window size, and the present embodiment can obtain the context window size according to a type of large model used; in response to determining that a length of the historical code content is less than or equal to the obtained context window size, obtaining the prompt for the current code generation subtask according to the task information and the historical code content corresponding to the current code generation subtask.

When executing S102 in the present embodiment, the following content can also be included: in response to determining that the length of the historical code content is greater than the obtained context window size, compressing the historical code content, wherein the purpose of compressing the historical code content in the present embodiment is to limit the length of the historical code content serving as a context within the context window size; obtaining the prompt for the current code generation subtask according to the task information corresponding to the current code generation subtask and a compression result of the historical code content.

When executing S102 to compress the historical code content in the present embodiment, the compression can be completed by extracting key code information from the historical code content, and the extracted key code information can include an interface definition, a style specification, and a function signature, etc.

When executing S102 to compress the historical code content in the present embodiment, the compression can also be completed by removing historical code content corresponding to a specific historical code file; In the present embodiment, the specific historical code file can be a historical code file generated in the previous N iterations, where N is a positive integer greater than or equal to 1.The present embodiment can determine the size of N according to how much the historical code content exceeds the context window size, thereby deleting historical code content corresponding to one or more historical code files generated earlier.

In other words, the present embodiment ensures that effective information is transmitted to the maximum extent possible under the limitation of the context window through a comparison between the context window size and the length of historical code content, thereby improving the accuracy of the obtained prompts corresponding to different code generation subtasks.

When executing S102 in the present embodiment, the following content can also be included: in response to determining that the current code generation subtask is a first code generation subtask, obtaining a task background information, wherein the task background information obtained in the present embodiment includes an overall architecture description, a technical specification, and a coding standard, etc.; obtaining the prompt for the first code generation subtask according to the task information of the first code generation subtask and the task background information.

In other words, when the large model executes the first code generation subtask in the present embodiment, the prompt corresponding to the subtask can be obtained by obtaining the task background information, so that the code file corresponding to the first code generation subtask generated by the large model conforms to a corresponding architecture, technical specification, or coding standard, thereby improving the accuracy of subsequent code file generation.

Furthermore, when executing S102 in the present embodiment, when executing different code generation subtasks, only the task information corresponding to the code generation subtask can be input into the large model, and then according to an output result of the large model, a code file corresponding to the code generation subtask can be obtained.

After generating the plurality of code files respectively corresponding to each of the code generation subtasks when executing S102 in the present embodiment, S103 is executed to obtain a code generation result corresponding to the code generation requirement according to the plurality of code files corresponding to the plurality of code generation subtasks.

In other words, after decomposing a multi-file code generation task corresponding to the code generation requirement into the plurality of ordered code generation subtasks in the present embodiment, the large model is used to execute different code generation subtasks sequentially to obtain the plurality of code files respectively corresponding to each of the code generation subtasks, thereby obtaining a code generation result corresponding to the code generation requirement.

When executing S103 in the present embodiment, the code content in each code file can be integrated, and then according to an integration result, a code generation result corresponding to the code generation requirement can be obtained; Alternatively, a preset code architecture can be obtained, the preset code architecture and a plurality of code files can be combined, and then a code generation result corresponding to the code generation requirement can be obtained according to a combined result.

Since the present embodiment adopts a progressive code generation strategy and performs chained transmission of a context, the accuracy of the generated code files can be improved, thereby improving the accuracy of the obtained code generation result.

FIG. 2 is a schematic diagram according to a second embodiment of the present application. As shown in FIG. 2, when executing S101 “obtaining a plurality of code generation subtasks and an execution order of the plurality of code generation subtasks according to a code generation requirement” in the present embodiment, an implementation method can be as follows:
S201, Obtaining a task key information according to the code generation requirement using the large model;
S202, Constructing a file dependency graph according to the task key information, wherein nodes in the file dependency graph represent code files, and edges between the nodes represent dependency relationships between the code files;
S203, Obtaining the plurality of code generation subtasks and the execution order of the plurality of code generation subtasks according to the file dependency graph.

In other words, the present embodiment can use the large model to obtain a task key information corresponding to the code generation requirement, construct a file dependency graph according to the obtained task key information, and then complete acquisition of code generation subtasks and an execution order according to the constructed file dependency graph, which can improve the accuracy of the obtained code generation subtasks and execution order.

The task key information obtained by using the large model according to the code generation requirement when executing S201 in the present embodiment can include required code file information (such as the number of code files, the functions supported by code files, etc.), dependency relationships between code files, and technology stack requirements for code generation, etc.

When executing S201 in the present embodiment, a code architecture information can be further obtained, and then the code architecture information and the code generation requirement can be input into the large model together, which can improve the accuracy of the task key information obtained using the large model.

When executing S202 in the present embodiment, the file dependency graph is constructed by identifying which code files need to reference other code files based on the code file information and the dependencies between code files in the task key information. This ensures that the constructed file dependency graph includes accurate nodes and edges between nodes.

When executing S203 in the present embodiment, a plurality of code generation subtasks can be first obtained according to different nodes in the constructed file dependency graph, that is, one node corresponds to one code generation subtask, and then the execution order of the plurality of code generation subtasks can be obtained according to edges between nodes in the file dependency graph, achieving the goal of decomposing the multi-file code generation task into a plurality of ordered single-file generation subtasks.

Furthermore, when executing S202 to construct the file dependency graph according to the task key information in the present embodiment, the following content can also be included: in response to determining that the number of code files in the task key information is greater than a preset threshold, constructing the file dependency graph according to the task key information.

In other words, the present embodiment can adopt progressive generation and chained context transmission to obtain the code generation result when determining that there are many code files to be generated, thereby avoiding waste of computing resources.

If the present embodiment determines that the number of code files to be generated is small when executing S202, an existing code generation method, such as a single full-scale generation method, can be used to obtain the code generation result.

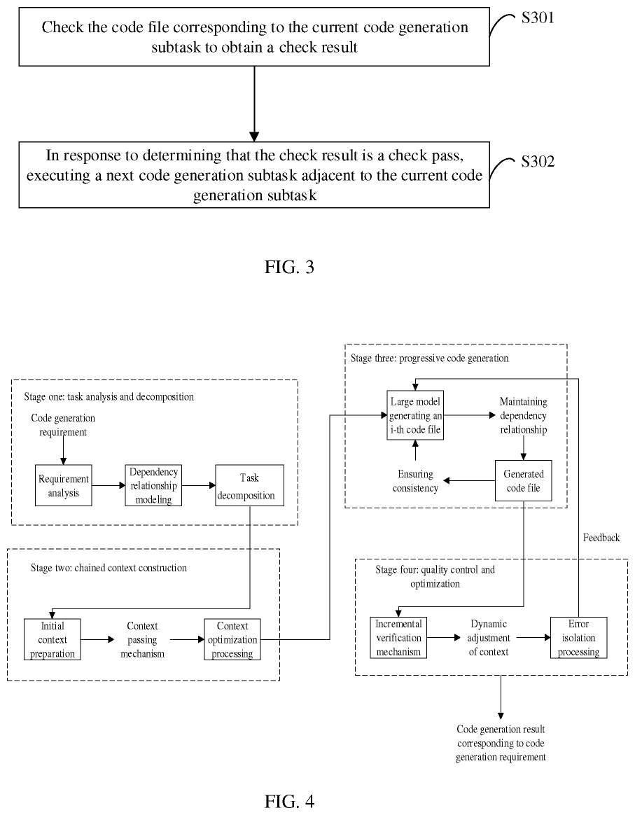

FIG. 3 is a schematic diagram according to a third embodiment of the present application. As shown in FIG. 3, after executing S102 “obtaining a code file corresponding to the current code generation subtask” in the present embodiment, the following content can also be included:
S301, Checking the code file corresponding to the current code generation subtask to obtain a check result;
S302, In response to determining that the check result is a check pass, executing a next code generation subtask adjacent to the current code generation subtask.

In other words, the present embodiment can perform syntax checking, dependency relationship verification, and code specification checking, etc. on each code file after the code file is generated, so as to continue executing a subsequent code generation subtask when determining that the check result is a check pass, thereby avoiding the generation of an incorrect code file that affects generation of a subsequent code file.

When executing S302 in the present embodiment, the following content can also be included: in response to determining that the obtained check result is a check failure, obtaining a check information, wherein the check information in the present embodiment can be error information of the code file; inputting the obtained check information and the prompt corresponding to the current code generation subtask into the large model, to cause the large model to regenerate the code file corresponding to the current code generation subtask.

In other words, the present embodiment can dynamically adjust context content of a subsequent code file through feedback and a check result in the generation process, and after a problem is discovered, a targeted adjustment can be made to regenerate a corresponding code file without causing a chain reaction, thus greatly reducing the complexity of error handling.

FIG. 4 is a schematic diagram according to a fourth embodiment of the present application. FIG. 4 shows a flowchart when the present embodiment performs he process for generating chained code based on a large model: as can be seen from FIG. 4, the present embodiment divides the code generation into four stages: stage one (task analysis and decomposition), stage two (chained context construction), stage three (progressive code generation), and stage four (quality control and optimization).

In the stage one, a plurality of ordered code generation subtasks are obtained according to the code generation requirement is completed; a requirement analysis is used to obtain task key information, a dependency relationship modeling is used to construct a file dependency graph, and a task decomposition is used to obtain the plurality of ordered code generation subtasks.

In the stage two, a chained context is constructed, that is, when generating an i-th (i is greater than 1) code file, a prompt is obtained according to all previously generated code files (code file 1 to code file i-1), and the code files include a code content; an initial context preparation is used to obtain the code file of the first code generation subtask, and a context optimization processing is used to compress historical code content.

In the stage three, a progressive code generation is completed, where different code files are generated by a large language model, and the dependency relationships of different code files are maintained and the consistency of different code files is ensured during the generation process.

In the stage four, a quality control and optimization are completed, that is, each generated code file is checked, thereby regenerating a code file that fails the check; an incremental verification mechanism is used to check the generated code files, an error isolation processing is used to regenerate a code file that fails the check, and then a code file that passes the check is fed back to serve as a context.

Therefore, through the above four stages, the present embodiment completes the chained code generation based on a large model, which can significantly improve the quality of generated code (dependency relationship integrity and code consistency), reduce the technical barrier and usage cost, enhance the system stability and maintainability, thereby providing a differentiated competitive advantage and promoting popularization and application of AI technology.

Furthermore, in the present embodiment, when the large language model executes the current code generation subtask in the execution order, in addition to inputting the task information of the corresponding current code generation subtask into the large language model, it also inputs the historical code content of the corresponding current code generation subtask into the large language model. This achieves the goal of chaining the previously generated code content as context, so that when the large language model generates code files corresponding to different code generation subtasks, it can reference the relevant information defined in the previous code content to accurately establish the dependency relationship between different code files, and ensure a high degree of consistency in specifications, patterns, etc. of different code files throughout the entire generation process.

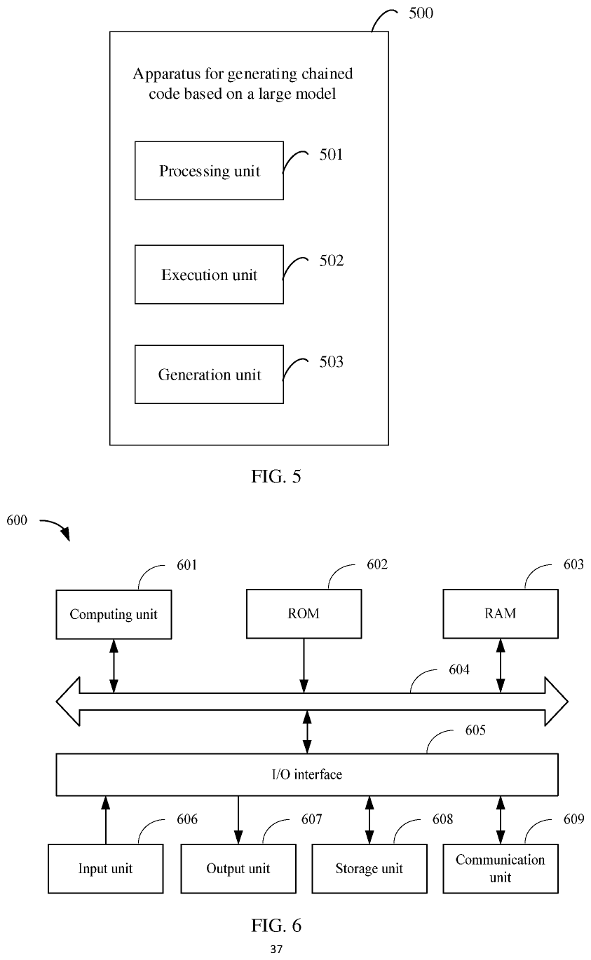

FIG. 5 is a schematic diagram according to a fifth embodiment of the present application. As shown in FIG. 5, the apparatus 500 for generating chained code based on a large model of the present embodiment includes:
a processing unit 501 configured to obtain a plurality of code generation subtasks and an execution order of the plurality of code generation subtasks according to a code generation requirement;
an execution unit 502 configured to execute the plurality of code generation subtasks sequentially according to the execution order using a large model to generate a plurality of code files respectively corresponding to each of the code generation subtasks;
a generation unit 503 configured to obtain a code generation result corresponding to the code generation requirement according to the plurality of code files corresponding to the plurality of code generation subtasks.

In the present embodiment, the large model can be a large language model (LLM) or can be a Multimodal Large Model (MLM).

The processing unit 501 can obtain an input from a user at an input terminal as the code generation requirement; wherein the code generation requirement of the present embodiment is used to reflect a function to be implemented by code to be generated, for example, “help me generate a real estate agency application” input by the user is treated as the code generation requirement.

Different code generation subtasks obtained by the processing unit 501 according to the code generation requirement are used to generate different code files, and the different code files include different code content; that is, each code generation subtask in the present embodiment is a single code file generation task.

Each code generation subtask obtained by the processing unit 501 has corresponding task information, and different task information is used to reflect different generation requirements; wherein different code generation subtasks correspond to different task information, and the task information includes clearly defined input content, a generation target, and a quality constraint.

After obtaining the plurality of code generation subtasks, the processing unit 501 further obtains an execution order of each code generation subtask, and different execution orders are used to reflect generation orders of different code files.

This is because, in a multi-code-file generation scenario, a reference relationship inevitably exists between different code files, and the reference relationship reflects a dependency situation between code files; if the execution order of code generation subtasks is not determined, a problem that a dependent code file is generated later than a code file that depends on the dependent code file is likely to occur, thereby affecting the accuracy of the generated code files.

Therefore, the processing unit 501 determines the execution order of each code generation subtask based on a principle of “prioritizing the generation of dependent basic code files and gradually building the dependency hierarchy upwards”, ensuring that a dependent code file is generated before a code file that depends on the dependent code file.

The processing unit 501 can obtain a plurality of code generation subtasks and the execution order of the plurality of code generation subtask according to information included in the code generation requirement; For example, if the code generation requirement input by the user includes a plurality of code files that the user needs and the dependency relationships between different code files, the present embodiment can obtain a plurality of code generation subtasks and the execution order of the plurality of code generation subtask according to the corresponding information directly extracted from the code generation requirement.

When obtaining the plurality of code generation subtasks and the execution order of the plurality of code generation subtask according to the code generation requirement, the processing unit 501 can also adopt the following implementation method: obtaining a task key information according to the code generation requirement using a large model; constructing a file dependency graph according to the task key information, wherein nodes in the file dependency graph represent code files, and edges between the nodes represent dependency relationships between the code files; obtaining a plurality of code generation subtasks and the execution order of the plurality of code generation subtask according to the file dependency graph.

In other words, the processing unit 501 can use the large model to obtain task key information corresponding to the code generation requirement, construct a file dependency graph according to the obtained task key information, and then complete acquisition of code generation subtasks and an execution order according to the constructed file dependency graph, which can improve the accuracy of the obtained code generation subtasks and the execution order.

The task key information obtained by the processing unit 501 using the large model according to the code generation requirement can include the required code file information (such as the number of code files, functions supported by code files, etc.), the dependency relationships between code files, and the technology stack requirements for code generation, etc.

The processing unit 501 can further obtain a code architecture information, and then input the code architecture information and the code generation requirement into the large model together, which can improve the accuracy of the task key information obtained using the large model.

The processing unit 501 can complete the construction of the file dependency graph by identifying which code files need to reference other code files according to the code file information in the task key information and the dependency relationships between code files, so that the constructed file dependency graph includes accurate nodes and edges between the nodes.

The processing unit 501 can first obtain a plurality of code generation subtasks according to different nodes in the constructed file dependency graph, that is, one node corresponds to one code generation subtask, and then obtain the execution order of the plurality of code generation subtask according to edges between nodes in the file dependency graph, achieving the goal of decomposing a multi-file code generation task into a plurality of ordered single-file generation subtasks.

Furthermore, when constructing the file dependency graph according to the task key information, the processing unit 501 can also include the following content: in response to determining that the number of code files in the task key information is greater than a preset threshold, constructing the file dependency graph according to the task key information.

In other words, if the processing unit 501 determines that a large number of code files need to be generated, it can use a progressive generation method and chained context passing to obtain the code generation result, thereby avoiding waste of computing resources.

If the processing unit 501 determines that the number of code files to be generated is small, an existing code generation method, such as a single full-scale generation method, can be used to obtain the code generation result.

After the processing unit 501 obtains the plurality of code generation subtasks and the execution order of the plurality of code generation subtask in the present embodiment, the execution unit 502 uses the large model to sequentially execute a plurality of code generation subtasks according to the execution order to generate the plurality of code files respectively corresponding to each of the code generation subtasks.

In other words, the execution unit 502 calls the large model multiple times according to the execution order to execute different code generation subtasks, thereby generating code files corresponding to different code generation subtasks by the large model through progressive code generation, and the generated code files include corresponding code content.

Since the large model only needs to focus on generating one specific file when executing a different code generation subtask each time, the generation target is relatively clear and the generation complexity is also relatively controllable. Therefore, during the generation process, the attention of the large model can be fully concentrated on the current task, avoiding the attention dilution problem when generating long sequences.

Specifically, when the execution unit 502 uses the large model to sequentially execute the plurality of code generation subtasks according to the execution order to generate the plurality of code files respectively corresponding to each of the code generation subtasks, an implementation method can be as follows: for a current code generation subtask, obtaining a prompt for the current code generation subtask according to a task information corresponding to the current code generation subtask and historical code content, where the prompt in the present embodiment is a Prompt; inputting the prompt into the large model, and obtaining a code file corresponding to the current code generation subtask according to an output result of the large model.

In other words, when the execution unit 502 executes different code generation subtasks by the large model, it uses not only the task information of the current code generation subtask but also the historical code content corresponding to the current subtask. This allows the large model to “see” all previously determined related code content when generating the code file for the current subtask, thus preventing the “forgetting” of preceding code information during the generation process.

Therefore, in the code file generation process of the present embodiment, the code content of a preceding code file is used as a context for chained transmission. On the one hand, this ensures that the large model can accurately reference components, functions, variables, styles, and other information defined in the preceding code file when executing different code generation sub-tasks, ensuring the accurate establishment of dependencies between different code files and achieving the goal of maintaining dependencies during the generation process. On the other hand, it ensures that the large model can follow established specifications and patterns when executing different code generation sub-tasks, thereby ensuring that the generated different code files have consistent coding styles, naming conventions, architectural paradigms, etc., achieving the goal of ensuring consistency during the generation process.

In the present embodiment, when the execution unit 502 obtains the prompt for the current code generation subtask according to the task information and the historical code content corresponding to the current code generation subtask, the historical code content can be first extracted from a historical code file, then the extracted code content and task information can be combined, and a combined result can be treated as the prompt for the current code generation subtask.

In the present embodiment, the historical code file corresponding to the current code generation subtask refers to all historical code files obtained before executing the current code generation subtask; therefore, the historical code content in the present embodiment is all code content included in the historical code files.

However, in an actual usage scenario, the code generation subtasks obtained by decomposing according to a code generation requirement will include a plurality of subtasks. If the number of code generation subtasks is too large, it can lead to an issue where the context input length exceeds the limit when using historical code content as the context for a particular subtask.

Therefore, when the execution unit 502 obtains the prompt for the current code generation subtask according to the task information and the historical code content corresponding to the current code generation subtask, an implementation method can be as follows: obtaining a context window size, and the present embodiment can obtain the context window size according to a type of large model used; in response to determining that a length of the historical code content is less than or equal to the obtained context window size, obtaining the prompt for the current code generation subtask according to the task information and the historical code content corresponding to the current code generation subtask.

The execution unit 502 can also execute the following content: in response to determining that the length of the historical code content is greater than the obtained context window size, compressing the historical code content, wherein the purpose of compressing the historical code content in the present embodiment is to limit the length of the historical code content serving as a context within the context window size; obtaining the prompt for the current code generation subtask according to the task information corresponding to the current code generation subtask and a compression result of the historical code content.

In the present embodiment, when the execution unit 502 compresses the historical code content, the compression can be completed by extracting a key code information from the historical code content, and the extracted key code information can include an interface definition, a style specification, and a function signature, etc.

When the execution unit 502 compresses the historical code content, the compression can also be completed by removing historical code content corresponding to a specific historical code file; in the present embodiment, the specific historical code file can be a historical code file generated in the previous N iterations, where N is a positive integer greater than or equal to 1, and the present embodiment can determine the size of N according to how much the historical code content exceeds the context window size, thereby deleting historical code content corresponding to one or more historical code files generated earlier.

In other words, the execution unit 502 ensures that effective information is transmitted to the maximum extent possible under the limitation of the context window through a comparison between the context window size and the length of historical code content, thereby improving accuracy of the obtained prompts corresponding to different code generation subtasks.

The execution unit 502 can also execute the following content: in response to determining that the current code generation subtask is a first code generation subtask, obtaining a task background information, wherein the task background information obtained in the present embodiment includes an overall architecture description, a technical specification, and a coding standard, etc. ; obtaining the prompt for the first code generation subtask according to the task information of the first code generation subtask and the task background information.

In other words, when the execution unit 502 has the large model execute the first code generation subtask, the prompt corresponding to the subtask can be obtained by obtaining task background information, so that the code file corresponding to the first code generation subtask generated by the large model conforms to a corresponding architecture, technical specification, or coding standard, thereby improving accuracy of subsequent code file generation.

After obtaining the code file corresponding to the current code generation subtask, the execution unit 502 can also execute the following content: checking the code file corresponding to the current code generation subtask to obtain a check result; in response to determining that the check result is a check pass, executing a next code generation subtask adjacent to the current code generation subtask.

In other words, the execution unit 502 can perform syntax checking, dependency relationship verification, and code specification checking, etc. on each code file after the code file is generated. Only after the check result is a check pass can subsequent code generation subtasks be executed, thus avoiding the generation of erroneous code files that could affect the generation of later code files.

The execution unit 502 can also execute the following content: in response to determining that the obtained check result is a check failure, obtaining check information, wherein the check information in the present embodiment can be an error information of the code file; inputting the obtained check information and the prompt corresponding to the current code generation subtask into the large model, to cause the large model to regenerate the code file corresponding to the current code generation subtask.

In other words, the execution unit 502 can dynamically adjust context content of a subsequent code file through the feedback and the check result in the generation process, and after a problem is discovered, a targeted adjustment can be made to regenerate a corresponding code file without causing a chain reaction, thereby greatly reducing the complexity of error handling.

Furthermore, when the execution unit 502 executes different code generation subtasks, only task information corresponding to a code generation subtask can be input into the large model, and then a code file corresponding to the code generation subtask can be obtained according to an output result of the large model.

After the execution unit 502 generates code files respectively corresponding to the plurality of code generation subtasks in the present embodiment, the generation unit 503 obtains a code generation result corresponding to the code generation requirement according to a plurality of code files corresponding to the plurality of code generation subtasks.

In other words, after decomposing a multi-file code generation task corresponding to the code generation requirement into a plurality of ordered code generation subtasks in the present embodiment, the large model is used to sequentially execute different code generation subtasks to obtain code files respectively corresponding to each of the code generation subtasks, thereby obtaining a code generation result corresponding to the code generation requirement.

The generation unit 503 can integrate the code content in each code file, and then obtain a code generation result corresponding to the code generation requirement according to an integration result; Alternatively, a preset code architecture can be obtained, the preset code architecture and a plurality of code files can be combined, and then a code generation result corresponding to the code generation requirement can be obtained according to a combined result.

Since the present embodiment adopts a progressive code generation strategy and performs chained transmission of a context, the accuracy of the generated code files can be improved, thereby improving the accuracy of the code generation result obtained by the generation unit 503.

In the technical solutions of the present application, the acquisition, storage, and application of user personal information involved all comply with the provisions of relevant laws and regulations, and do not violate public order and good customs.

According to embodiments of the present application, the present application also provides an electronic device, a readable storage medium, and a computer program product.

As shown in FIG. 6, this is a block diagram of an electronic device for the method for generating chained code based on a large model according to embodiments of the present application. The electronic device is intended to represent various forms of digital computers, such as a laptop computer, a desktop computer, a workstation, a personal digital assistant, a server, a blade server, a mainframe computer, and other suitable computers. The electronic device can also represent various forms of mobile devices, such as a personal digital processing device, a cellular telephone, a smart phone, a wearable device, and other similar computing devices. The components shown herein, their connections and relationships, and their functions are merely examples, and are not intended to limit an implementation of the present application described and/or claimed herein.

As shown in FIG. 6, a device 600 includes a computing unit 601, which can execute various appropriate actions and processing according to a computer program stored in a read-only memory (ROM) 602 or a computer program loaded from a storage unit 608 into a random access memory (RAM) 603. In the RAM 603, various programs and data required for operation of the device 600 can also be stored. The computing unit 601, the ROM 602, and the RAM 603 are connected to each other through a bus 604. An input/output (I/O) interface 605 is also connected to the bus 604.

Multiple components in the device 600 are connected to the I/O interface 605, including: an input unit 606, such as a keyboard, a mouse, etc.; an output unit 607, such as various types of displays, speakers, etc.; a storage unit 608, such as a magnetic disk, an optical disk, etc.; and a communication unit 609, such as a network card, a modem, a wireless communication transceiver, etc. The communication unit 609 allows the device 600 to exchange information/data with other devices through a computer network such as the Internet and/or various telecommunication networks.

The computing unit 601 can be various general and/or special processing components with processing and computing capabilities. Some examples of the computing unit 601 include but are not limited to a central processing unit (CPU), a graphics processing unit (GPU), various dedicated artificial intelligence (AI) computing chips, various computing units running a machine learning model algorithm, a digital signal processor (DSP), and any appropriate processor, controller, or microcontroller, etc. The computing unit 601 executes various methods and processing described above, such as the method for generating chained code based on a large model. For example, in some embodiments, the method for generating chained code based on a large model can be implemented as a computer software program, which is tangibly contained in a machine-readable medium, such as the storage unit 608.

In some embodiments, part or all of the computer program can be loaded and/or installed onto the device 600 via the ROM 602 and/or the communication unit 609. When the computer program is loaded into the RAM 603 and executed by the computing unit 601, one or more steps of the method for generating chained code based on a large model described above can be executed. Alternatively, in other embodiments, the computing unit 601 can be configured to execute the method for generating chained code based on a large model through any other appropriate means (for example, by means of firmware).

Various implementations of the systems and techniques described herein can be implemented in a digital electronic circuit system, an integrated circuit system, a field programmable gate array (FPGA), an application specific integrated circuit (ASIC), an application specific standard product (ASSP), a system on chip (SOC) system, a complex programmable logic device (CPLD), computer hardware, firmware, software, and/or combinations thereof. These various implementations can include: implementation in one or more computer programs, wherein the one or more computer programs can be executed and/or interpreted on a programmable system including at least one programmable processor, wherein the programmable processor can be a dedicated or general-purpose programmable processor, can receive data and instructions from a storage system, at least one input device, and at least one output device, and transmit data and instructions to the storage system, the at least one input device, and the at least one output device.

Program code for implementing the methods of the present application can be written in any combination of one or more programming languages. The program code can be provided to a processor or a controller of a general-purpose computer, a special-purpose computer, or other programmable apparatus for generating chained code based on a large model, so that when the program code is executed by the processor or the controller, the functions/operations specified in the flowcharts and/or block diagrams are implemented. The program code may execute entirely on a machine, partly on a machine, as a stand-alone software package partly on a machine and partly on a remote machine, or entirely on a remote machine or a server.

In the context of the present application, a machine-readable medium can be a tangible medium that may contain or store a program for use by or in connection with an instruction execution system, apparatus, or device. The machine-readable medium can be a machine-readable signal medium or a machine-readable storage medium. The machine-readable medium can include but is not limited to an electronic, a magnetic, an optical, an electromagnetic, an infrared, or a semiconductor system, apparatus, or device, or any suitable combination of the foregoing. More specific examples of a machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein can be implemented on a computer having: a display device (for example, a CRT (cathode ray tube) or LCD (liquid crystal display) monitor) for displaying information to the user; and a keyboard and a pointing device (for example, a mouse or a trackball) through which the user may provide input to the computer. Other kinds of devices can also be used to provide interaction with the user; for example, feedback provided to the user can be any form of sensory feedback (for example, visual feedback, auditory feedback, or tactile feedback); and input from the user can be received in any form (including acoustic input, speech input, or tactile input).

The systems and techniques described herein can be implemented in a computing system that includes a backend component (for example, as a data server), or a computing system that includes a middleware component (for example, an application server), or a computing system that includes a frontend component (for example, a user computer having a graphical user interface or a web browser through which the user may interact with implementations of the systems and techniques described herein), or a computing system that includes any combination of such a backend component, a middleware component, or a frontend component. The components of the system can be interconnected by any form or medium of digital data communication (for example, a communication network). Examples of a communication network include: a local area network (LAN), a wide area network (WAN), and the Internet.

The computer system can include a client and a server. The client and the server are generally remote from each other and typically interact through a communication network. The relationship of the client and the server arises by virtue of computer programs running on respective computers and having a client-server relationship to each other. The server can be a cloud server, also called a cloud computing server or a cloud host, which is a host product in the cloud computing service system, solving the defects of difficult management and weak business scalability existing in a traditional physical host and a VPS service (“Virtual Private Server”, or “VPS” for short). The server can also be a server of a distributed system, or a server combined with a blockchain.

It should be understood that various forms of processes shown above can be used, with steps reordered, added, or deleted. For example, the steps described in the present application can be executed in parallel, sequentially, or in different orders, as long as the desired results of the technical solutions disclosed in the present application can be achieved, which are not limited herein.

The above specific implementations do not constitute limitations on the protection scope of the present application. A person skilled in the art should understand that various modifications, combinations, sub-combinations, and substitutions can be made according to design requirements and other factors. Any modifications, equivalent substitutions, and improvements made within the spirit and principles of the present application shall be included within the protection scope of the present application.

What is claimed is:

1. A method for generating chained code based on a large model, comprising:
obtaining a plurality of code generation subtasks and an execution order of the plurality of code generation subtasks according to a code generation requirement;
executing the plurality of code generation subtasks sequentially according to the execution order using a large model to generate a plurality of code files respectively corresponding to each of the code generation subtasks;
obtaining a code generation result corresponding to the code generation requirement according to the plurality of code files corresponding to the plurality of code generation subtasks.

2. The method according to claim 1, wherein obtaining the plurality of code generation subtasks and the execution order of the plurality of code generation subtasks according to the code generation requirement comprises:
obtaining a task key information according to the code generation requirement using the large model;
constructing a file dependency graph according to the task key information, wherein nodes in the file dependency graph represent code files, and edges between the nodes represent dependency relationships between the code files;
obtaining the plurality of code generation subtasks and the execution order of the plurality of code generation subtasks according to the file dependency graph.

3. The method according to claim 1, wherein executing the plurality of code generation subtasks sequentially according to the execution order using the large model to generate the plurality of code files respectively corresponding to each of the code generation subtasks comprises:
obtaining a prompt for the current code generation subtask according to a task information and a historical code content corresponding to the current code generation subtask;
inputting the prompt into the large model, and obtaining a code file corresponding to the current code generation subtask according to an output result of the large model.

4. The method according to claim 3, wherein obtaining the prompt for the current code generation subtask according to the task information and the historical code content corresponding to the current code generation subtask comprises:
obtaining a context window size;
in response to determining that a length of the historical code content is less than or equal to the obtained context window size, obtaining the prompt for the current code generation subtask according to the task information and the historical code content corresponding to the current code generation subtask.

5. The method according to claim 4, further comprising:
in response to determining that the length of the historical code content is greater than the obtained context window size, compressing the historical code content;
obtaining the prompt for the current code generation subtask according to the task information corresponding to the current code generation subtask and a compression result of the historical code content.

6. The method according to claim 3, further comprising:
in response to determining that the current code generation subtask is a first code generation subtask, obtaining a task background information;
obtaining the prompt for the first code generation subtask according to the task information of the first code generation subtask and the task background information.

7. The method according to claim 3, further comprising:
checking the code file corresponding to the current code generation subtask to obtain a check result;
in response to determining that the check result is a check pass, executing a next code generation subtask adjacent to the current code generation subtask.

8. The method according to claim 7, further comprising:
in response to determining that the obtained check result is a check failure, obtaining a check information;
inputting the obtained check information and the prompt corresponding to the current code generation subtask into the large model, to cause the large model to regenerate the code file corresponding to the current code generation subtask.

9. The method according to claim 2, wherein constructing the file dependency graph according to the task key information comprises:
in response to determining that the number of code files in the task key information is greater than a preset threshold, constructing the file dependency graph according to the task key information.

10. An electronic device, comprising:
at least one processor; and
a memory communicatively connected with the at least one processor;
wherein the memory stores instructions executable by the at least one processor, and the instructions are executed by the at least one processor to enable the at least one processor to perform a method for generating chained code based on a large model, wherein the method for generating chained code based on a large model comprises:
obtaining a plurality of code generation subtasks and an execution order of the plurality of code generation subtasks according to a code generation requirement;
executing the plurality of code generation subtasks sequentially according to the execution order using a large model to generate a plurality of code files respectively corresponding to each of the code generation subtasks;
obtaining a code generation result corresponding to the code generation requirement according to the plurality of code files corresponding to the plurality of code generation subtasks.

11. The electronic device according to claim 10, wherein obtaining the plurality of code generation subtasks and the execution order of the plurality of code generation subtasks according to the code generation requirement comprises:
obtaining a task key information according to the code generation requirement using the large model;
constructing a file dependency graph according to the task key information, wherein nodes in the file dependency graph represent code files, and edges between the nodes represent dependency relationships between the code files;
obtaining the plurality of code generation subtasks and the execution order of the plurality of code generation subtasks according to the file dependency graph.

12. The electronic device according to claim 10, wherein executing the plurality of code generation subtasks sequentially according to the execution order using the large model to generate the plurality of code files respectively corresponding to each of the code generation subtasks comprises:
obtaining a prompt for the current code generation subtask according to a task information and a historical code content corresponding to the current code generation subtask;
inputting the prompt into the large model, and obtaining a code file corresponding to the current code generation subtask according to an output result of the large model.

13. The electronic device according to claim 12, wherein obtaining the prompt for the current code generation subtask according to the task information and the historical code content corresponding to the current code generation subtask comprises:
obtaining a context window size;
in response to determining that a length of the historical code content is less than or equal to the obtained context window size, obtaining the prompt for the current code generation subtask according to the task information and the historical code content corresponding to the current code generation subtask.

14. The electronic device according to claim 13, further comprising:
in response to determining that the length of the historical code content is greater than the obtained context window size, compressing the historical code content;
obtaining the prompt for the current code generation subtask according to the task information corresponding to the current code generation subtask and a compression result of the historical code content.

15. The electronic device according to claim 12, further comprising:
in response to determining that the current code generation subtask is a first code generation subtask, obtaining a task background information;
obtaining the prompt for the first code generation subtask according to the task information of the first code generation subtask and the task background information.

16. The electronic device according to claim 12, further comprising:
checking the code file corresponding to the current code generation subtask to obtain a check result;
in response to determining that the check result is a check pass, executing a next code generation subtask adjacent to the current code generation subtask.

17. The electronic device according to claim 16, further comprising:
in response to determining that the obtained check result is a check failure, obtaining a check information;
inputting the obtained check information and the prompt corresponding to the current code generation subtask into the large model, to cause the large model to regenerate the code file corresponding to the current code generation subtask.

18. The electronic device according to claim 11, wherein constructing the file dependency graph according to the task key information comprises:
in response to determining that the number of code files in the task key information is greater than a preset threshold, constructing the file dependency graph according to the task key information.

19. A non-transitory computer readable storage medium with computer instructions stored thereon, wherein the computer instructions are used for causing a method for generating chained code based on a large model, wherein the method for generating chained code based on a large model comprises:
obtaining a plurality of code generation subtasks and an execution order of the plurality of code generation subtasks according to a code generation requirement;
executing the plurality of code generation subtasks sequentially according to the execution order using a large model to generate a plurality of code files respectively corresponding to each of the code generation subtasks;
obtaining a code generation result corresponding to the code generation requirement according to the plurality of code files corresponding to the plurality of code generation subtasks.

20. The non-transitory computer readable storage medium according to claim 19, wherein obtaining the plurality of code generation subtasks and the execution order of the plurality of code generation subtasks according to the code generation requirement comprises:
obtaining a task key information according to the code generation requirement using the large model;
constructing a file dependency graph according to the task key information, wherein nodes in the file dependency graph represent code files, and edges between the nodes represent dependency relationships between the code files;
obtaining the plurality of code generation subtasks and the execution order of the plurality of code generation subtasks according to the file dependency graph.
